(19) United States
(12) Patent Application Publication
(10) Pub. No.: US 2024/0067852 A1
(43) Pub. Date: Feb. 29, 2024

(54) ADHESIVE COMPOSITION COMPRISING LUPINE PROTEIN AND LIGNIN

(71) Applicant: ORGANOCLICK AB, Täby (SE)

(72) Inventors: Maria WENNMAN, Täby (SE); Deniz DEMIRCAN, Sollentuna (SE)

(73) Assignee: ORGANOCLICK AB, Täby (SE)

(21) Appl. No.: 18/552,690

(22) PCT Filed: Mar. 25, 2022
(86) PCT No.: PCT/SE2022/050290

§ 371 Date: Sep. 27, 2023

(30) Foreign Application Priority Data
Mar. 30, 2021 (SE) 2150391-7

(51) Int. Cl. C09J 189/00; B27N 3/00; C09J 5/00; C09J 197/00

(52) U.S. Cl. CPC C09J 189/00; B27N 3/002; C09J 5/00; C09J 197/005; B27N 3/02

(57) ABSTRACT

The present invention relates generally to an aqueous adhesive composition comprising lignin and a source of lupine protein. The invention further relates to a method for gluing together two or more surfaces of a material using said aqueous adhesive composition, use of said aqueous adhesive composition and a material treated with said aqueous adhesive composition.

### TECHNICAL FIELD

The present invention relates generally to an aqueous adhesive composition comprising lignin and a source of lupine protein. The invention further relates to a method for gluing together two or more surfaces of a material using said aqueous adhesive composition, use of said aqueous adhesive composition and a material treated with said aqueous adhesive composition.

### BACKGROUND ART

Water-based adhesives, such as adhesives based on polyvinyl acetate, are increasingly popular due to their economic viability. However, most adhesives with high performance usually consist of synthetic polymers made from non-renewable resources such as for instance polyacrylates, polyurethanes and polyvinyl esters.

In an attempt to reduce the usage of synthetic polymers, the industry has turned its attention to lignin which is the second most prevalent biopolymer after cellulose. Previously, lignin was for long considered a by-product from the paper making process and was usually burned for its fuel value. In recent years, with the development of technologies enabling the extraction of highly purified lignin from the paper making process, lignin has been studied as an alternative to synthetic polymers due to its polyaromatic structure.

It is desirable that a water-based adhesive contains as low water content as possible. Water acts as a carrier of the binding component and needs to be removed during drying. Hence, a water-based adhesive with a low solid content will require a longer drying time of an adhesive treated material, and hence longer production time and tack time. Tack time is the time required for an adhesive to start exhibit adhesion, i.e. bonding, of two surfaces

When developing an aqueous adhesive composition made from renewable resources, it is desirable to develop a composition exhibiting similar solid contents and viscosity as conventional synthetic adhesives. If the solid content is lower than a conventional adhesive, the drying time will increase and hence lead to an increase in manufacturing costs. Another drawback of a low solid content is that the adhesive will not exhibit initial tack, which results in no adhesion. Moreover, if the viscosity is different, it might not be possible to use the newly developed adhesive with conventional equipment, as they are adapted to specific viscosity ranges. Therefore, these parameters are of great importance.

The usage of vegetable proteins in lignin-based adhesives is known. Previous attempts have been made to incorporate soy protein into lignin-based adhesives, such as in US 2010/0089287 A1 or US 2016/0333240 A1. However, due to soy protein's inability to achieve high solid contents in a dispersion due to viscosity concerns, these systems tend to have a lower solid content compared to conventional adhesives, thus resulting in a longer drying time. A solution has been to enzymatically modify the soy protein. However, this results in an expensive additional manufacturing step.

Lupine is a genus of about 200 species of plants in the pea family. They are extensively cultivated both as a food resource and as ornaments.

Previously, lupine protein has been used to reduce the amount of synthetic polymer in an aqueous based adhesive, see for instance US 2013/0252007 A1. However, the adhesive composition disclosed in this document still comprises a substantial amount of synthetic polymer.

Vidal et al “Evaluation of lupin flour (LF)-based adhesive for making sustainable wood materials” http://www.swst.org/meetings/AM10/ppts/Vidal.pdf, showed that lupine protein denaturated with urea combined with polyamideamine epichlorohydrin could exhibits similar characteristics as a conventional urea-formaldehyde resin.

Compositions of lignin and lupine have been used for instance to provide bactericidal compositions, see for instance application CN 109380243 A. However, CN 109380243 A does not discuss adhesive properties of a lignin-lupine based adhesive.

US 2013005867 A1 discloses different adhesive compositions used in preparation of lignocellulosic based composites. The adhesives are based on polyamidoamine-epichlorohydrin (PAE) type resins.

There is thus still a need for an aqueous adhesive composition comprising high amounts, or completely made of, renewable materials that exhibit similar characteristics as conventional synthetic aqueous adhesives.

### SUMMARY OF INVENTION

An object of the present invention is to provide an environmentally friendly aqueous adhesive composition comprising a high amount, or completely made of, renewable materials.

It is also an object of the present invention to provide an environmentally friendly aqueous adhesive composition with as low water content as possible, thereby reducing the drying time of the adhesive and reducing manufacturing costs.

It is another object of the present invention to provide an aqueous adhesive composition exhibiting a short tack time.

It is another object of the present invention to provide an aqueous adhesive composition with improved flame retardancy compared to conventional aqueous adhesive compositions.

It is another object of the present invention to provide an aqueous adhesive composition that can dry at relatively low temperatures, for instance at room temperature.

It is still another object of the present invention to provide an aqueous adhesive composition that readily can form films with a suitable flexibility.

Any combination of the above objects is also possible.

In one general aspect, the invention relates to an aqueous adhesive composition comprising;
(a) lignin; and
(b) a source of lupine protein,
   wherein the combined wt % of the lignin and the source of lupine protein in the aqueous adhesive composition is at least 30%, and wherein the weight ratio between the source of lupine protein and lignin in the aqueous adhesive composition is between 1:3 and 5:1, preferably between 1:2 and 3:1, even more preferably between 1:1 and 2:1. By an aqueous adhesive composition according to the present invention, an adhesive composition comprising a high amount, or completely made of, renewable materials is achieved. Furthermore, by combining lignin and a source of lupine protein in an aqueous adhesive composition, it has surprisingly been found that the composition will exhibit higher adhesive strength, i.e. energy at break, compared to an aqueous adhesive composition made of the individual components alone. Furthermore, it was found that an aqueous adhesive composition according to the present invention exhibits similar or higher energy at break values compared to conventional polyvinyl acetate glue. There is thus a synergistic effect in combining lupine protein with lignin.

By maintaining the combined wt % of the lignin and source of lupine protein in the aqueous adhesive composition to at least 30%, a sufficiently strong adhesive, i.e. energy at break, can be achieved while still exhibiting similar viscosities as conventional synthetic adhesives such as polyvinyl acetate.

The ratio between the source of lupine protein and lignin in the aqueous adhesive composition is an important parameter for controlling the required properties necessary for the intended use of the composition, such as strength parameters and/or flexibility. The Applicant has surprisingly found that by selecting a suitable ratio between the source of lupine protein and lignin according to the present invention, it was possible to control properties, such as strength and/or flexibility, of the adhesive composition depending on the desired use.

In the context of the present invention, lupine protein refers to protein from beans of plants in the legume family Fabaceae. The lupine protein may be provided in the form of lupine flour, containing from about 40 wt % to about 99 wt % of lupine protein.

It is important that the water content is as low as possible in an aqueous adhesive composition since the water acts as a carrier of the binding component and needs to be removed during a drying step. The more water to evaporate, the longer time for drying of the glue line, hence longer tack time. Furthermore, it is important that the aqueous adhesive composition exhibit similar viscosities to conventional glues. It was found that compared to other protein from leguminous plants, such as for instance soy, lupine protein could be added to water in a higher amount before the target viscosity, i.e. the viscosity of polyvinyl acetate, was achieved. Hence, more binding component can be added when using lupine protein instead of other protein from leguminous plants, such as soy for instance.

The aqueous adhesive composition is formed by mixing the components of the adhesive in any conventional way as described in prior art, for instance by combining liquid dispersions of the components, or by combining the substances in dry form and forming a dispersion.

In one aspect, the aqueous adhesive composition is a dispersion.

In one aspect, the weight ratio between the source of lupine protein and lignin in the aqueous adhesive composition is about 1:1. It was found that a weight ratio of about 1:1 between the source of lupine protein and lignin results in an adhesive with high energy at break values and good flexibility of the resulting adhesive film.

A flexible film is desirable as the formed film needs to be able to withstand mechanical movements within the glued material, as well as handling of the glued product. An inflexible film will break when subjected to mechanical movements and thus impair the adhesion of the glued material.

In one aspect, the weight ratio between the source of lupine protein and lignin in the aqueous composition is between 1:1 and 1:2.

In one aspect, the aqueous adhesive has a viscosity, measured with a Brookfield DV-II+Pro LV Viscometer together with Rheocal software using spindle LV64 at 100 RPM, of from about 2000 to about 5500 mPas, preferably from about 3000 to about 5500 mPAs, preferably from about 3500 to about 5500 mPAs, even more preferably from about 4000 to about 5000 mPas. By ensuring that the composition is within conventional viscosity ranges, the aqueous adhesive composition according to the present invention can be utilized as an alternative to conventional synthetic adhesive compositions exhibiting similar viscosity.

In one aspect, the source of lupine protein is in the form of a lupine flour comprising at least 40 wt % lupine protein, preferably at least 50 wt % lupine protein, even more preferably at least 55 wt % lupine protein. In one aspect, the source of lupine protein is in the form of a lupine flour comprising between 40-70 wt % lupine protein, preferably between 50-60 wt % lupine protein.

In one aspect, the combined wt % of the lignin and the source of lupine protein in the aqueous adhesive composition is at least 40%, preferably at least 45%, preferably at least 48%, preferably at least 50%. In one aspect, the combined wt % of the lignin and the source of lupine protein in the aqueous adhesive composition is about 50%.

In one aspect, the aqueous adhesive composition further comprises at least one additional compound selected from an acid, a base, a hardener, a filler, a pigment, a thickener, a defoaming agent, a softener, a preservative and/or a flame-retardant compound. Preferably, the at least one additional compound is selected from xanthan gum, glycerol and sorbitol. Said additional compound are selected depending on the application method and the expected properties of the final material, wherein the concentration of the additive is 0-30 wt %, more preferably 0-20 wt %, most preferably 0-10 wt %.

The hardener may be selected from one or more of tris(hydroxymethyl)nitromethane (TRIS), glyoxal (GLY), and hexamethylene-tetramine (HEX) for instance.

The filler may be selected from one or more of gum arabic, konjac glucomannan, organic fillers such as wood flour, starch soy flour, olive seed flour, cork flour, corn cobs, rice brain husks, and inorganic fillers such as calcium carbonate, glass fibre, kaolin, talc and mice and other fillers known to the skilled person.

The preservative may be selected from one or more of fungicide, bactericide, pharmaceutical preservative, cosmetic preservative and food preservatives. The inclusion of a preservative helps to inhibit the growth of mold in the aqueous adhesive composition.

In one aspect, the aqueous adhesive composition further comprises a wet strength agent, preferably the wet strength agent is selected from at least one of starch, such as starch particles, granules or dissolved starch, synthetic binders, such as latex, modified biopolymers, such as modified starches, proteins, and other natural polysaccharides, such as sodium carboxymethyl cellulose, guar gum, chitosan and hemicelluloses.

In one aspect, the lignin is a lignin generated from the Kraft process, for instance alkaline lignin generated from the Kraft process, In one aspect, the alkaline lignin is used as a dispersion comprising between from about 45 to about 50% lignin solid content, or can be mixed in dry form. The lignin used can be purified to remove any remaining sulphur impurities.

In another general aspect, the present invention is directed to a method for adhering a first and a second surface together, comprising:
a) applying an aqueous adhesive composition as defined in any one of the previously mentioned aspects to at least one of said first or second surfaces;
b) placing said first and second surfaces in contact with each other, such that the aqueous adhesive composition is located between said surfaces;
c) optionally drying the contacted surfaces at a temperature of 10 to 175 degrees C., more preferably 10 to 160 degrees C., even more preferably 10 to 90 degrees C.

In one aspect, the drying is performed in a hot press at a temperature of 10 to 175 degrees C., preferably 20 to 160 degrees C., even more preferably 100 to 155 degrees C.

The aqueous adhesive composition is typically applied onto the surface by spraying, coating, brushing, ribbon application or liquid extrusion for instance.

The drying can be performed using any drying techniques such as microwave, IR, pulse, induction, air drying, Kiln-drying, Dehumidification, Vacuum-drying, Solar kiln, Water seasoning, Boiling or steam seasoning, Chemical or salt seasoning, Electrical seasoning, hot press and similar. The method can be performed in the absence or presence of vacuum, inert atmosphere, steam, or ambient atmosphere.

In one aspect, said first and/or second surfaces comprises or consist of a wood or cellulose material, a wood based or cellulose based composite material such as plywood, particle board, or fibre boards (i.e. LDF, MDF or HDF), moulding compounds such as pulp moulded products, cellulose based materials such as paper, paperboard, cardboard, carton, or corrugated fibreboard, nonwoven materials (e.g. airlaid, wetlaid, spunbond, spunlace, drylaid, etc.) made completely or partly of cellulosic (e.g. viscose) or wood fibres, textile made of cellulosic fibres such as cotton, linen, hemp, viscose, etc. A wood or cellulose based composite material might be made completely, or substantially, of wood or cellulose based materials.

The wooden material used with the present invention can be selected from, but are not limited to, e.g. spruce, pine, birch, oak, redwood, cedar or composite materials such as plywood, fibre boards, particle boards, or pulp-based materials such as paperboard, corrugated board, gypsum grade paperboard or moulded pulp products.

In one aspect, said first surface comprises or consist of a wood or cellulose material, a wood based or cellulose based composite material such as plywood, fibre board, or particle board, molding compounds such as pulp moulded products, cellulose based materials such as paper, paperboard, cardboard, carton, or corrugated fibreboard, nonwoven materials (e.g. airlaid, wetlaid, spunbond, spunlace, drylaid, etc.) made completely or partly of cellulosic (e.g. viscose) or wood fibres, textile made of cellulosic fibres such as cotton, linen, hemp, viscose, etc., and said second surface comprises or consist of a structural element such as a wall, floor or ceiling. This enables the adhesion of an object to a fixed structural element. The structural element can be an inside structural element or an outside structural element. A wood or cellulose based material might be made completely of, or substantially made of wood or cellulose based materials.

In one aspect, the aqueous adhesive composition is added in an amount of from about 80 g/m² to about 180 g/m² based on dry on, preferably from about 100 g/m² to about 150 g/m² based on dry on, and even more preferably from about 110 g/m² to about 130 g/m² based on dry on.

In one aspect, the drying results in physical curing of the aqueous adhesive composition. By physical curing, is meant the evaporation of the dispersive phase of the aqueous adhesive composition so to generate the phenomenon of adhesion and cohesion of the adhesive.

In another general aspect, the present invention is directed to a use of an aqueous adhesive composition as defined in any one of the previous aspects, for adhering a first and a second surface together. In one aspect, said first and/or second surfaces comprises or consist of a wood or cellulose material, a wood based or cellulose based composite material such as plywood, fibre board, or particle board, molding compounds such as pulp moulded products, cellulose based materials such as paper, paperboard, cardboard, carton, or corrugated fibreboard, nonwoven materials (e.g. airlaid, wetlaid, spunbond, spunlace, drylaid, etc.) made completely or partly of cellulosic (e.g. viscose) or wood fibres, textile made of cellulosic fibres such as cotton, linen, hemp, viscose, etc. A wood or cellulose based material might be made completely of, or substantially made of wood or cellulose based materials.

In one aspect, said first surface comprises or consist of a wood or cellulose material, a wood based or cellulose based composite material such as plywood, fibre board, or particle board, molding compounds such as pulp moulded products, cellulose based materials such as paper, paperboard, cardboard, carton, or corrugated fibreboard, nonwoven materials (e.g. airlaid, wetlaid, spunbond, spunlace, drylaid, etc.) made completely or partly of cellulosic (e.g. viscose) or wood fibres, textile made of cellulosic fibres such as cotton, linen, hemp, viscose, etc., and wherein said second surface comprises or consist of a structural element such as a wall, floor or ceiling. A wood or cellulose based material might be made completely of, or substantially made of wood or cellulose based materials.

In another general aspect, the present invention relates to a material treated with an aqueous composition as defined in any one of the previous aspects.

In one aspect, said material is a wood or cellulose based material, a wood based or cellulose based composite material, plywood, fibre board, particle board, molding compounds such as pulp moulded products, or cellulose based materials such as paper, paperboard, cardboard, carton or corrugated fibreboard, or nonwoven materials (e.g. airlaid, wetlaid, spunbond, spunlace, drylaid, etc.) made completely or partly of cellulosic (e.g. viscose) or wood fibres, or textile made of cellulosic fibres such as cotton, linen, hemp, viscose, etc.

### DESCRIPTION OF EMBODIMENTS

In the following, a detailed description of the present invention is provided.

As used herein, “wt %” refers to weight percent of the ingredient, or ingredients, referred to of the total weight of the compound or composition referred to.

As used herein in the present experiments, “solid content” refers to the percent of the ingredient, or ingredients, referred to left in the composition once the volatile solvent, e.g. water, has vaporized, and is for example the combined wt % of lignin and source of lupine protein.

As used herein, “about” refers to a measurable value, such as an amount, meant to encompass variations of +/−10% or less, preferably +/−5% or less, even more preferably +/−1% or less, and still more preferably +/−0.1% or less of and from the specified value, in so far the skilled person understands that such variations are appropriate to perform in the disclosed invention. However, it is to be understood that the value to which “about” refers to is itself also specifically disclosed.

### Chemicals

Chemicals used for the present invention are listed in Table 1. Moreover, Polyvinylacetate (PVAc) glue was used as reference glue material. HCl and white pigment (titanium dioxide) were used as additives.

TABLE 1
Specifications for lupine and soy protein powders

| | | | | Soluble | | | Saturated | |
|---|---|---|---|---|---|---|---|---|
| Name | Particle size | Protein | Carbohydrates | sugars | Fibres | Fat | fatty acids | Ash |
| Lupine protein 1 | | 50-60 | 7.6 | 7.6 | 14.6 | 9.8 | 2 | 2.5-3.5 |
| Lupine protein 2 | 98% < 500 um | 18-22 | 3-7 | 1-2 | 56-61 | 3-7 | 0.9 | 2-4 |
| Lupine protein 3 | 100% < 800 um, | 36-40 | 6-10 | 6-10 | 32-38 | 7-11 | 1-2 | 3-4 |
| | 95% < 500 um | | | | | | | |
| Soy protein 1 | 95% < 150 um | >47 | >25 | | >15 | >8 | | |
| Soy protein 2 | 99% < 180 um | 50 | 13.5 | 13.1 | 17 | 1.7 | 0.4 | 6-7 |

### Equipment

All equipment used in the following examples are listed below.
pH in formulations was measured with pHenomenal pH1000H from VWR with Hamilton Polilyte Lab Temp BNC electrode (calibrated with buffers pH 4, 7 and 10).
T-peel tests were conducted using Testometric M250-2.5AT (machine capacity 2.5 kN) together with Wintest Analysis software.
The adhesive formulations were prepared by using IKA Werke under at 1000 rpm for 30 minutes.
Viscosity of formulations were measured with Brookfield DV-II+ Pro LV Viscometer together with Rheocal software using spindle LV64 at 100 rpm.

### Methods

In the following section, all methods referred to in the examples are described.
Method A: Two layers of the biocomposite material OrganoComp™ with the dimensions of 2 cm*10 cm was glued together by spreading the adhesive composition over an area of 2 cm*6 cm on the edges of the substrate. The two substrates were then assembled and pressed. 120 g/m2 glue was applied based on dry add-on.
Method B: A flame was held vertical to the film for 10 seconds and then removed. Waiting time before the flame was held towards the material again was 10-15 seconds. The number of repetitions before the material started to burn is reported as the flame score. If no fire in the material was observed after seventh repetition, the test was stopped. Hence, the best flame score is 7.
Method C: 180-degree T-peel test. Specimen were produced according to Method A and mounted between the clamps in Testometric M250-2.5AT (load cell: 250 kgf) after having test specimens for at least 20 h in 23° C. and 50% RH. The distance between the clamps was 7 cm and crosshead speed was 140 mm/min. The test was finished when the specimens were entirely peeled off. The test is adapted from Standard Test Method for Peel Resistance of Adhesives (T-Peel Test), D 1876.
Method D: The adhesive composition was spread on petri dish and left overnight for air drying.
Method E: Two layers of cardboard with the dimensions of 500*1000 cm was glued together by applying a thin layer of adhesive with a brush and then the two layers were assembled. The construction was put under 0.3 bar for 4 min.
Method F: Two layers of wood veneers with the dimension of 2 cm*10 cm was glued together by gluing 2 cm*2 cm area on one edge of one veneer, and then two veneers were assembled and pressed under 2 kg at 150° C. for 3 min. 120 g/m2 adhesive was applied based on dry add-on. Veneers were conditioned before gluing for 24 h at 23° C. and 50% RH.
Method G: Dry strength. Specimens were prepared according to the Method F and mounted between the clamps in Testometric M250-2.5AT (load cell: 250 kgf) after having test specimens for minimum 24 h at 23° C. and 50% RH. The distance between the clamps was 10 cm and crosshead speed was 25 mm/min.

### Experiments

The following sector contains experiments that support the invention.

Experiment 1. Evaluating Proteins and Their Combinations with Lignin.

Method A was used to compare lupin protein, soy protein and lignin (separate and in combination) to commercial PVAc glue. As high solid content as possible was used. Hence, the different proteins have different capacity of forming high concentrated formulations. Method C was used for evaluation the test specimen. Results are shown in Table 2.

TABLE 2
Water dispersions of proteins and their combinations with lignin.
Adhesive strength of different adhesive formulations.

| Adhesive dispersion (solid | Ratio Protein | Energy at |
|---|---|---|
| content, %) | to Lignin | Break (Nm) |
| Lignin (48%) | | 0.01 |
| Lupine protein 1 (50%) | | 0.11 |
| Lupine protein 2 (33%) | | 0.01 |
| Lupine protein 3 (33%) | | 0.08 |
| Lupine protein 1/Lignin + HCl (50%) | 1:1 | 0.26 |
| Lupine protein 1/Lignin (45%) | 1:1 | 0.27 |
| Lupine protein 1/Lignin (45%) | 3:1 | 0.67 |
| Lupine protein 1/Lignin (45%) | 5:1 | 0.15 |
| Lupine protein 1/Lignin (45%) | 1:3 | 0.12 |
| Soy protein 1/Lignin (39%) | 1:1 | 0.01 |
| Soy protein 2/Lignin (3%) | 1:1 | 0.31 |
| Lupine protein 2/Lignin (39%) | 1:1 | 0.05 |
| Lupine protein 3/Lignin (39%) | 1:1 | 0.07 |
| Lupine protein 1/Lignin/Pigment (57%) | 8:8:1 | 0.51 |
| PVAc (50%) | | 0.15 |

The data from Table 2 shows that lupine protein itself and in combination with lignin can be produced with as high solid content as PVAc glue.

Different lignin to lupine ratios were mixed and tested to achieve the best glue strength. The dispersion with higher lignin content (1:3) exhibited the best glue performance both in terms of strength and film forming property. Besides those, the flame score was good (see Experiment 3) which is an advantage when it comes to flame retardant glue applications. Also increasing up the lignin to lupine ratio from 1:1 to 3:1 is a plus since the larger part of the adhesive is from a non-food sourced sustainable feedstock.

The data from Table 2 shows that there is a synergistic effect between lignin and lupine protein. All the combinations of lupine protein and lignin has higher energy at break than that of the commercial synthetic adhesive. The effect of mixing lupine protein with lignin on adhesive strength is significantly higher than mixing soy protein with lignin for one version of soy protein but for the other version of soy protein, the glue line is as strong for the lupin mixture as for the soy protein mixture. However, for the best soy protein mixed with lignin there are several drawbacks. One is that the solid content which is limited to 39% due to the high viscosity. The other is the brittleness in the film (see Experiment 2). Together, the two drawbacks will limit the use of such adhesive dramatically.

Colouring the brown lignin/lupine adhesive with white pigment yield three better adhesive property such as better shear strength, higher dry content and a whiter adhesive. On the other hand, viscosity was decreased while solid content was increased. The low viscosity helps with better penetration ability of substrate (better wetting) and hence exhibit better gluing. And high dry content is an advantage since it shortens drying time.

### Experiment 2. Film Forming Property

Film formation ability is crucial for adhesives in most cases. To investigate the glue line by the film forming property, Method D was used to prepare films. Table 3 includes comments about the appearance of different films.

TABLE 3
Comments on films prepared of the dispersions

| | Ratio | |
|---|---|---|
| Adhesive dispersion (solid | protein to | |
| content %) | lignin | Comment |
| Lignin (48%) | | Brittle |
| Lupine protein (50%) | | Brittle |
| Lupine protein 1/Lignin + | 1:1 | Flexible. 180 degree |
| hydrochloric acid (45%) | | bending without break. |
| Lupine protein 1/Lignin (45%) | 1:1 | Flexible. 180 bending |
| | | without break. |
| Lupine protein 1/Lignin (45%) | 3:1 | Brittle |
| Lupine protein 1/Lignin (45%) | 5:1 | Brittle |
| Lupine protein 1/Lignin (45%) | 1:3 | Flexible. 180 degree |
| | | bending without break. |
| Lupine protein 1/Lignin/pigment | 8:8:1 | Flexible. 180 degree |
| (57%) | | bending without break. |
| PVAc (50%) | | Flexible. 180 degree |
| | | bending without break. |
| Lupine protein 3 (33%) | | Brittle |
| Lupine protein 3/Lignin (39%) | 1:1 | Brittle |
| Lupine protein 2 (33%) | | Brittle |
| Lupine protein 2/Lignin (39%) | 1:1 | Brittle |
| Soy protein 1, (33%) | | Brittle |
| Soy protein 1/Lignin (39%) | 1:1 | Brittle |
| Soy Protein 2 (33%) | | Brittle |
| Soy protein 2/Lignin (39%) | 1:1 | Brittle |

The conclusion from this test was that the biobased adhesive based on the combination between lupine protein and lignin can be produced with the same advantage of being flexible and tough as a plastic PVAc glue.

### Experiment 3. Flame Retardancy

To study the inherent flame-retardant property of the different dispersion, a flame test according to Method B was performed. Films for the test were produced according to Method D. Results are seen in Table 4.

TABLE 4
Flame test on glue films.

| | Ratio protein | |
|---|---|---|
| Adhesive films | to lignin | Flame score |
| Lignin | — | 7 |
| Lupine protein 1 | — | 1 |
| Lupine protein 1/Lignin + | 1:1 | 4 |
| hydrochloric acid | | |
| Lupine protein 1/Lignin | 1:1 | 4 |
| Lupine protein 1/Lignin | 3:1 | 4 |
| Lupine protein 1/Lignin | 5:1 | 4 |
| Lupine protein 1/Lignin | 1:3 | 7 |
| PVAc | | 1 |

From Table 4 it is obvious that the lignin contributes with flame retardancy to the adhesive which is beneficial in many applications. A flame-retardant adhesive is of high interest in construction and decorative products for indoor use.

### Experiment 4. Viscosity Measurements

It is important to reach the same viscosity with similar solid content as for synthetic PVAc glue to be able to use the biobased adhesive as a “drop in” candidate for existing equipment used in different industries. Table 5 below shows measured solid content and viscosities.

TABLE 5
Solid content and viscosity for different adhesives

| | | Ratio | Viscosity at 100 |
|---|---|---|---|
| | Solid | protein to | rpm, spindel LV64 |
| Adhesive dispersion | content | lignin | (mPas) |
| Lignin | 48 | | 30000 |
| Lupine protein 1 | 50 | | Out of range |
| Lupine protein 1/Lignin | 45 | 1:1 | 4180 |
| Lupine protein 1/Lignin | 48 | 1:1 | 22000 |
| Lupine protein 1/Lignin | 45 | 1:3 | 23155 |
| Lupine protein 1/Lignin | 48 | 1:3 | 28000 |
| Lupine protein 1/Lignin/ | 57 | 8:8:1 | 1824 |
| Pigment | | | |
| PVAc | 52 | | 4000-5000 |

Based on the Table 5, it can be concluded that it is possible, with small adjustments on the solid content, to tune the viscosity for a certain technique or equipment of application (spraying, rolling etc).

### Experiment 5. Gluing Larger Objects

Not only small lab samples need to pass the gluing test to confidently say that the glue has properties similar to synthetic PVAc glue. For this reason, cardboard panels with the dimension of 500 cm*1000 cm OrganoComp™ were glued according to Method E. The combination of Lupine protein 1:Lignin with ratio 1:1 with 48-50% solid content was used. When tearing the two panels apart, fibre tear was observed. On the other hand, for the commercial PVAc glue no fibre tear was observed. For panels glued with pigmented glue (Lupine protein 1:Lignin:pigment with ratio 8:8:1) with 50% solid content, it was hard to even initiate failure test which eventually resulted in material break rather than fibre tear. The conclusion was that larger objects are possible to glue with the same performance as synthetic glues.

### Experiment 6. Wood Gluing

Wood veneers bonded with PVAc and Lupine protein 1:Lignin with ratio 1:1 (45%) was prepared according to Method F. Tensile shear strengths of the wood veneers were determined according to the Method G. See the results in Table 6.

TABLE 6
The tensile shear strength of veneers bonded
with Lupine protein 1/Lignin and PVAc.

| Adhesive | Ratio protein | Tensile shear |
|---|---|---|
| dispersion | to lignin | strength (MPa) |
| Lupine protein 1/ | 1:1 | 1.2 |
| Lignin | | |
| PVAc | — | 1.1 |

The test shows that the biobased glue is as strong as the commercial PVAc glue for wooden substrates.

1. An aqueous adhesive composition comprising;
(a) lignin; and
(b) a source of lupine protein,
wherein the combined wt % of the lignin and source of lupine protein in the aqueous adhesive composition is at least 30%, and wherein the weight ratio between the source of lupine protein and lignin in the aqueous adhesive composition is between 1:3 and 5:1.

2. The aqueous adhesive composition according to claim 1, wherein the aqueous adhesive composition is a dispersion.

3. The aqueous adhesive composition according to claim 1, wherein the weight ratio between the source of lupine protein and lignin in the aqueous adhesive composition is about 1:1.

4. The aqueous adhesive composition according to claim 1, wherein the weight ratio between the source of lupine protein and lignin in the aqueous composition is between 1:1 and 1:2.

5. The aqueous adhesive composition according to claim 1, wherein the aqueous adhesive has a viscosity, measured with a Brookfield DV-II+Pro LV Viscometer together with Rheocal software using spindle LV64 at 100 RPM, of from about 2000 to about 5500 mPas.

6. The aqueous adhesive composition according to claim 1, wherein the source of lupine protein is in the form of a lupine flour comprising at least 40 wt % lupine protein.

7. The aqueous adhesive composition according to claim 1, wherein the combined wt % of the lignin and source of lupine protein in the aqueous adhesive composition is at least 40%.

8. The aqueous adhesive composition according to claim 1, wherein the aqueous adhesive composition further comprises at least one additional compound selected from an acid, a base, a hardener, a thickener, a curing agent, a filler, a pigment, a defoaming agent, a softener and a flame-retardant compound, the at least one additional compound is selected from xanthan gum, glycerol and sorbitol.

9. The aqueous adhesive composition according to claim 1, wherein the aqueous adhesive composition further comprises a wet strength agent, the wet strength agent is selected from at least one of starch, such as starch particles, granules or dissolved starch, synthetic binders, such as latex, modified biopolymers, such as modified starches, proteins, and other natural polysaccharides, such as sodium carboxymethyl cellulose, guar gum, chitosan and hemicelluloses.

10. The aqueous adhesive composition according to claim 1, wherein the lignin is an alkaline lignin generated from the Kraft process.

11. A method for adhering a first and a second surface together, comprising:
a) applying an aqueous adhesive composition as defined in claim 1 to at least one of said first or second surfaces;
b) placing said first and second surfaces in contact with each other, such that the aqueous adhesive composition is located between said surfaces;
c) optionally drying the contacted surfaces at a temperature of 10 to 175 degrees C.

12. The method according to claim 11, wherein the drying is performed in a hot press at a temperature of 10 to 175 degrees C.

13. The method according to claim 11, wherein said first and/or second surfaces comprises or consist of a wood or cellulose material, a wood based or cellulose based composite material such as plywood, fibre board, or particle board, molding compounds such as pulp moulded products, cellulose based materials such as paper, paperboard, cardboard, carton, or corrugated fibreboard, nonwoven materials made completely or partly of cellulosic or wood fibres, textile made of cellulosic fibres.

14. The method according to claim 11, wherein said first surface comprises or consist of a wood or cellulose material, a wood based or cellulose based composite material such as plywood, fibre board, or particle board, molding compounds such as pulp moulded products, cellulose based materials such as paper, paperboard, cardboard, carton, or corrugated fibreboard, nonwoven materials made completely or partly of cellulosic or wood fibres, textile made of cellulosic fibres, and wherein said second surface comprises or consist of a structural element such as a wall, floor or ceiling.

15. The method according to claim 11, wherein the aqueous adhesive composition is added in an amount of from about 80 g/m2 to about 180 g/m2 based on dry on.

16. The method according to claim 11, wherein the drying results in physical curing of the aqueous adhesive composition.

17. A method for adhering a first and a second surface together comprising:
using the aqueous adhesive composition as defined in claim 1, for adhering a first and a second surface together.

18. The method of claim 17, wherein said first and/or second surface comprises or consist of a wood or cellulose material, a wood based or cellulose based composite material such plywood, fibre board, or particle board, molding compounds such as pulp moulded products, cellulose based materials such as paper, paperboard, cardboard, carton, or corrugated fibreboard, nonwoven materials made completely or partly of cellulosic or wood fibres, textile made of cellulosic fibres.

19. The method of claim 17, wherein said first surface comprises or consist of a wood or cellulose material, a wood based or cellulose based composite material such plywood, fibre board, or particle board, molding compounds such as pulp moulded products, cellulose based materials such as paper, paperboard, cardboard, carton, or corrugated fibreboard, nonwoven materials made completely or partly of cellulosic or wood fibres, textile made of cellulosic fibres, and wherein said second surface comprises or consist of a structural element such as a wall, floor or ceiling.

20. A material treated with the aqueous composition as defined in claim 1.

21. The material according to claim 20, wherein said material is a wood or cellulose material, a wood based or cellulose based composite material such as plywood, fibre board, or particle board, molding compounds such as pulp moulded products, cellulose based materials such as paper, paperboard, cardboard, carton, or corrugated fibreboard, nonwoven materials made completely or partly of cellulosic or wood fibres, textile made of cellulosic fibres.
